(19) United States
(12) Patent Application Publication
(10) Pub. No.: US 2002/0020171 A1
(43) Pub. Date: Feb. 21, 2002

(54) Rotary machine

(76) Inventor: Ronald WIlliam Driver, Clitheroe (GB)

Correspondence Address: MORGAN, LEWIS & BOCKIUS, 1800 M STREET NW, WASHINGTON, DC, 20036-5869, US

(21) Appl. No.: 09/726,458

(22) Filed: Dec. 1, 2000

Related U.S. Application Data
(63) Continuation-in-part of application No. 08/973,523, filed on Dec. 5, 1997, now Pat. No. 6,226,986.
(63) Continuation-in-part of application No. 09/700,921, filed on Feb. 13, 2001.

(51) Int. Cl. F16D 31/02; F01C 1/00

(52) U.S. Cl. 60/397; 60/407; 418/61.1; 418/269

(57) ABSTRACT

An internal combustion engine in combination with a rotary positive displacement fluid machine. The combination having a rotor eccentrically mounted in a casing with a plurality of vanes defining compartments within the casing which vary in volume as the rotor rotates. Each vane is connected to a linkage to cause the vane, during rotation of the rotor, to pivot radially outwardly such that the outermost extremity of each vane is constrained to follow closely the internal wall of the casing. The linkage being constrained to follow at least one track in a member rotatable upon the same axis as the casing. The machine being connected to an air inlet manifold of the engine, and to atmosphere, such that the rotor is driven by the pressure difference between ambient air and air at the inlet manifold. The machine also is operatively connected to an energy using device.

### CROSS REFERENCE TO RELATED APPLICATIONS

This application is a Continuation-In-Part of U.S. patent application Ser. No. 08/973,523, filed Dec. 5, 1997, and a Continuation-In-Part of U.S. patent application Ser. No. 09/700,921, filed Nov. 21, 2000 (which is based on International Application No. PCT/GB99/01419). both of which are incorporated by reference herein in their entirety.

### FIELD OF THE INVENTION

This invention concerns rotary machines of the kind having a rotor eccentrically mounted within a casing the rotor having a plurality of movable vanes disposed about its circumference, each van being connected to means whereby it may swing inwardly and outwardly as the rotor rotates so that the tips of the vanes are constrained to follow closely the internal wall of the casing.

The machine operates such that gaseous fluid introduced into the spaces between the vanes is alternately compressed and expanded in different zones of the eccentric rotation. Valves or ports in the wall of the casing of the machine are provided for the supply or recovery of air or gases within the spaces whereby the machine may be used either as a compressor or a turbine, or both.

The machine has many uses such as enhancement of the efficiency and economic operation of an internal combustion engine that in certain cases can overcome the problems of throttle loss at low engine speeds, or it may operate as a heat pump.

The mechanism used to cause the vanes to swing inwardly and outwardly as the machine rotates, conventionally comprises a crank on the pivotal axis of each vane, the offset pivot of the crank being connected to a spoke rotationally mounted on the axis of the casing.

Particularly when such a machine is used as a heat pump or if the required speed is excessive the loads on the rotating connecting rods or spokes increase considerably. To maintain the bearing loads within acceptable limits the spokes must be of considerable thickness which, however, excessively increases the weight and the overall length of machine. To overcome this problem there have been proposals to dispense with the spokes and to provide, instead, a device which slides within a groove in a fixed end member. However, this presents further difficulties in the design and running conditions of the bearing surfaces of the sliding member and groove.

### SUMMARY OF THE INVENTION

An internal combustion engine in combination with a rotary positive displacement fluid machine. The combination having a rotor eccentrically mounted in a casing with a plurality of vanes defining compartments within the casing which vary in volume as the rotor rotates. Each vane is connected to a linkage to cause the vane, during rotation of the rotor, to pivot radially outwardly such that the outermost extremity of each vane is constrained to follow closely the internal wall of the casing. The linkage being constrained to follow at least one track in a member rotatable upon the same axis as the casing. The machine being connected to an air inlet manifold of the engine, and to atmosphere, such that the rotor is driven by the pressure difference between ambient air and air at the inlet manifold. The machine also is operatively connected to an energy using device.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1a is a schematic end view of a rotary machine of the kind incorporating the invention.

FIG. 1b is a schematic perspective view of part of the machine.

FIG. 1c is a cross-sectional view of a modified form thereof.

FIG. 1d is a representation of a rotor of a rotary machine.

FIG. 2 is a mechanical coupling for driving vanes.

FIG. 3 is a sectional side view of part of a device using the rotor of FIG. 1d.

FIG. 4 shows an inlet valve.

FIG. 5 shows porting for the rotor.

FIG. 6 shows similar porting.

FIG. 7 shows another rotor.

FIG. 8 is a longitudinal section through a rotor assembly.

FIGS. 9 to 11 are views of a crank arm.

FIGS. 12 to 14 illustrate mounting of spokes.

FIG. 15 is an axial schematic of the rotor.

FIG. 16 is a perspective view of a center casing.

FIG. 17 shows a modification.

FIG. 18 shows an example.

FIG. 18A shows a spoke.

FIG. 19 is a perspective of part of a rotary device.

FIG. 20 shows a device in an engine.

FIG. 20A is a schematic operating system.

FIG. 22 is a section view of a sleeve.

FIGS. 23 and 24 and 25 show forms of coupling.

FIG. 26 shows a heat exchanger circuit.

### DETAILED DESCRIPTION OF THE PREFERRED EMBODIMENT

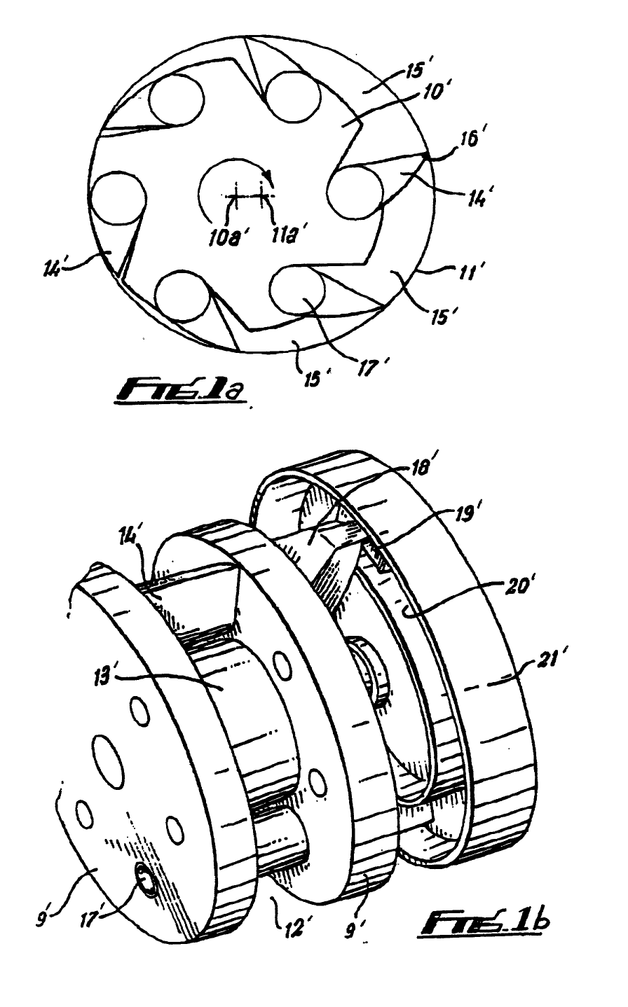

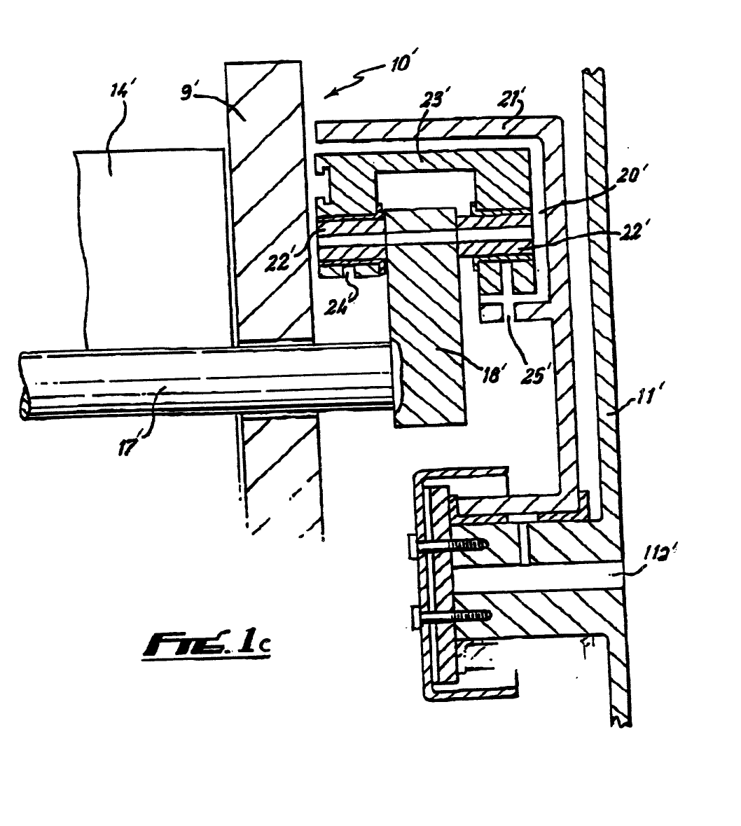

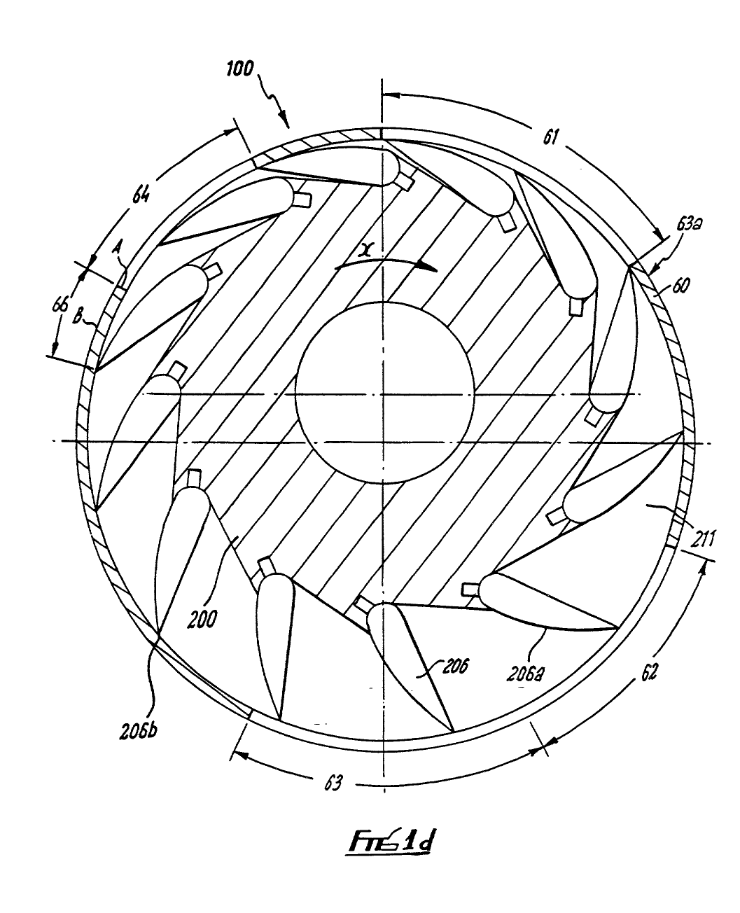

Referring now to FIGS. 1a and 1b of the drawings, in a rotary machine of the kind referred to there is provided a rotor 10′ adapted to rotate within a cylindrical casing 11′ the axes of the rotor (10a′) and the casing (11a′) being mutually offset. The rotor 10′ comprises a pair of axially spaced discs 9′ defining a central channel 12′ about the reduced circumference 13′ of which there is provided a series of pivotal vanes 14′ which thus divide the channel 12′ into a number of discrete arcuate spaces 15′. Such a machine is known, for example, from International Patent Publication No. WO 96/39571, which is hereby incorporated in its entirety by reference and is considered as part of this disclosure, and which is at least partially set forth below. The vanes 14′ are pivotally mounted about their innermost ends so that their tips 16′ are able to swing inwardly and outwardly in a general radial direction as the rotor rotates such that the tips 16′ may follow a circular path equivalent to the inner wall of the casing 11′. This can be seen from FIG. 1 a.

Thus, as the rotor 10′ is driven in rotation the spaces 15′ defined within the channel 12′ between the vanes 14′ are progressively enlarged and reduced in volume by the offset axes 10a′ and 11a′ of the rotor and casing. Therefore, gaseous fluid introduced into these spaces is alternatively compressed and expanded as the machine rotates, this expansion and compression being utilized for various purposes as referred to in the patent publication mentioned above.

In accordance with the invention there is provided an improved mechanism connected through one or both discs 9′ of the rotor 10′ to each vane 14′. On its axis of rotation at one or both ends of a shaft 17′ is a crank arm 18′ from the radially outer end of which there extends in a direction parallel to the shaft 17′ a slipper 19′ adapted to slide within a groove 20′ in an outer disc 21 ′ which is freely rotatably mounted on the axis 11a′ of rotation of the casing 11′.

The sliding engagement of the slipper 19′ within the groove 20′ ensures accurate varying displacement of the associated vane 14′ as the machine rotates. Since the disc 21′ is freely rotatable minimal bearing friction between the groove and the slipper is achieved.

Referring now to FIG. 1c in an improved embodiment the slipper 19′ is replaced by a pair of stub axles 22′ pivotally mounted within an enlarged slipper 23′ which again slides within a groove 20′ of the disc 21′. Lubrication ports 24′ and 25′ may be provided if required. By attaching the slipper 23′ in tandem, any tendency for bending or twisting movement on the crank arm 18′ is avoided or at least substantially reduced. The two bearings ensure that the load placed upon the slipper mechanism is more evenly distributed and reduces any stresses.

In the assembly illustrated in FIG. 1c, the item containing the lubrication port 25′ is, in effect, formed by the radial inner wall of the groove 20′. This prevents the slipper, and thus the vane tips, from moving radially inwardly at slow speeds when gaseous fluids within the spaces 15′ might otherwise overcome the centrifugal forces tending normally to move the vanes outwardly. The crank arm 18′ may be bonded to the vane shaft 17′ for ease of assembly. The crank arm 18′ may instead carry a clevis, with a roller bearing or the like mounted between the legs of the clevis. The slipper 19′, 23′ may carry, or be replaced by a pair of needle roller bearings for smoother running, which could therefore be grease sealed to avoid the need for oil lubrication.

As set forth above, International Patent Publication No. WO 96/39571 describes a rotary machine in which the above described mechanism can be employed, and as discussed below, can be used in various environments.

Rotary machines are known of the kind comprising:

(a) a casing;

(b) a rotor rotatable eccentrically in the casing and having means to define with the casing, peripheral compartments which are separate from each other;

(c) an inlet for the inflow of a fluid to the compartments sequentially as the rotor rotates;

(d) an outlet, displaced in the direction of rotation of the rotor from the inlet, for the outflow of said fluid, and

(e) a shaft whereby power can be supplied to or taken from said rotor.

Such machines can be adapted to perform an engine or expansion function by allowing a hot inlet gas to expand in the compartments as the compartments increase in volume and/or a compressor function by supplying an inlet gas to be compressed in the compartments as the compartments decrease in volume. The gas may be in the form of a vapor.

There are crank arms movable with their ends in a common path axially displaced from the region swept by the rotor and oscillating arms rotatable on and oscillatable about a pillar which is secured to or is a part of the casing, the oscillating arms being secured to the crank arms and the crank arms being secured to respective vanes so that the oscillating arms pivot the crank arms and hence the vanes to positions in which the tips of the vanes remain salient of that part of the rotor to which they are attached. The vanes and rotor define the compartments with the casing. The vanes oscillate in and out providing respective expansion and compression regions of van movement during a rotation. If the machine is used only for expansion or only for compression, the respective compression part or expansion part of the casing can be omitted. One example is shown in FIGS. 1d to 3.

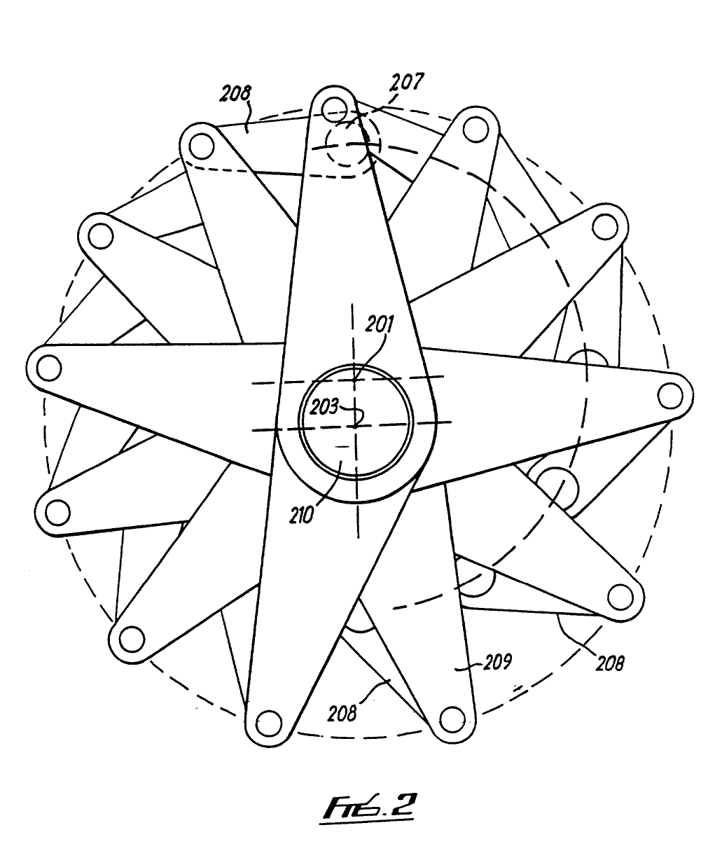

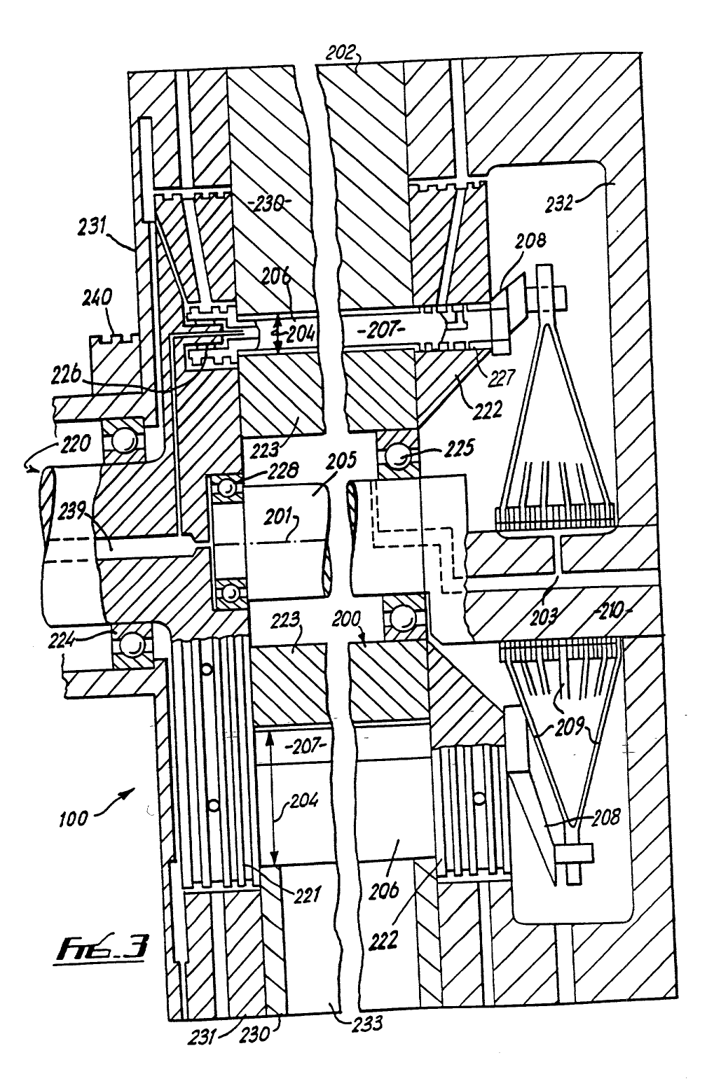

Referring to FIGS. 1d to 3, in FIG. 3 there is shown a rotary engine 100 having an engine rotor 200 with an axis 201 and a fixed truly cylindrical casing 202 with axis 203. The rotor 200 is seen to be eccentric in the casing 202 and defines with the casing an eccentric annulus 204. The rotor 200 is rotatable on a static axle 205 and is equipped with twelve angularly spaced vanes 206 carried on pivots, indicated by axes 207, and running in the casing with a very small clearance between their tips 206b and the inner surfaces of the casing. The vanes 206 are each respectively mechanically coupled to cranks 208 (now see FIG. 2) and the cranks 208 are oscillated by respective connecting arms 209 mounted on a casing pillar 210, and rotatable about axis 203. The vanes 206 define peripheral compartments 211 FIG. id in the eccentric annulus 204 which cyclically change in volume as the rotor 200 rotates. The rotor 200 is arranged for rotation in the direction of arrow x, FIG. 1d. The outer surfaces 206a of the vanes 206 are curved so that when the compartments 211 have smallest volume this surface substantially conforms to the inner surface of the casing and has a running clearance therewith.

Components 200 to 210 are also indicated in FIG. 3 and will now be described. The main static parts of the engine comprise the casing 202; casing pillar 210 with axis 203; and static axle 205 with axis 201. The main rotating parts of the engine comprise the rotor 200 which has a saw-tooth periphery and is rotatable about axis 201 of axle 205; vanes 206, rotatable about axes 207 at the roots of the saw teeth; cranks 208; and connecting arms 209. As shown in FIG. 1 d the vanes 206 substantially fully radially occupy the eccentric annulus 204 (indicated by “dimension” lines 204).

Other parts of the rotor are: an input or output shaft 220 integral with a sealing, bearing and lubricating front plate 221 and rear plate 222. Between the plates 221, 22 there is the main body 223 (200) of the rotor. The rotor is carried on bearings 224, 225, 228 and the vanes 206 are supported on bearings 226, 227, in the plates 221, 222.

Other parts of the casing are: the main block 230, the front cover plate 231 and rear cover plate 232. The block defines a radial exhaust port 233. The form and location of inlet ports will be determined by the function the machine has to perform. Oil passages 239 are indicated.

In the case of a machine with an engine function the expansion of the supplied gas typically takes place in the peripheral compartments 211 as they increase in volume and once they are beyond the supply cut-off point. This expansion applies a driving torque to the shaft 220. As the compartments 211 change in volume, the expanded gas is exposed to an exhaust port 233 that may typically angularly extend over about 5/12 of the circumference.

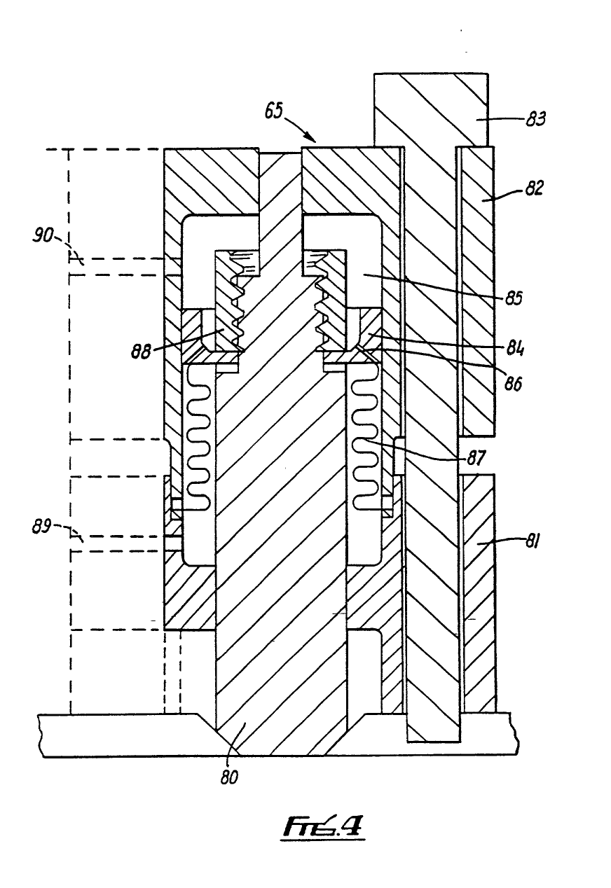

FIG. 1d illustrates a machine having casing 60 with expansion inlet 61, expansion exhaust port region 62, compressor inlet region 63, and compressor outlet region 64. At maximum design power and fuel consumption the vane tip 206b will have reached point A at the beginning of the compressor outlet region at the point of maximum compression. If fuel supply is now reduced or there is a change in working efficiency, the vane will reach the angular point of appropriate compression before point A, e.g. point B, and to avoid over-pressure being obtained as a result of rotation from B to A, valves are provided, responsive to pressure in the adjacent compartment. The valves control ports in region 66 of the casing extending upstream of B. There are typically nine valves 65 giving a nine-step adjustment and they are located as shown in FIG. 5 indicating the upstream edge C of the exhaust port.

Each valve is associated with a respective sensor 65 a for the compartment pressure at the circumferential position of the valve and connected to the pressure tapping described later. The connection is indicated schematically at 65b for valves 1, 8 but omitted from the other valves for clarity. The valves overlap so that the angular extent of any over-pressurizing is reduced or eliminated. Over-pressurizing should preferably be of angular extent of no more than a half valve diameter.

The sensors 65a are located in the circumferential part of the casing and may comprise a hollow tube communicating at an inner end with an aperture in the casing and at an outer end with connection 65b. Region 66 is immediately upstream of the upstream edge of the outlet 64 from the compression region.

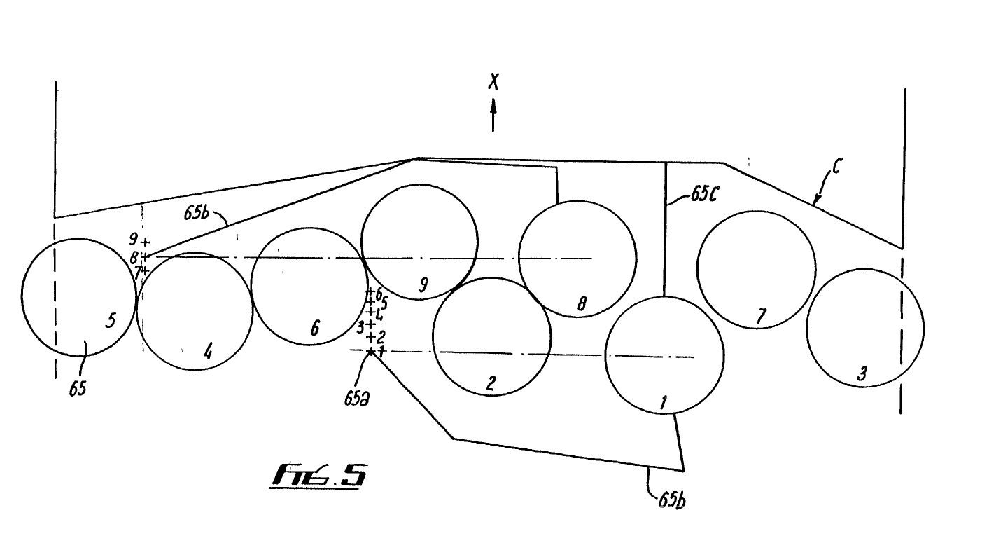

Similarly, in the case of a compression machine, there is an expansion inlet region 71 FIG. 7, expansion exhaust port region 72, compressor inlet region 73, compressor outlet region 74. Valves 65 are located in region 75, to avoid suction in the expansion stage, and in region 76, to avoid over-pressure in the compression stage, with typical locations of the valve ports in region 76 shown in FIG. 6. There may typically be nine valves 65 in the region 75.

It is preferable to have valves 65 also immediately downstream of the inlet regions 61, 71 in casing regions 63a, 73a. This enables the acceleration of the rotor to be increased by increasing the drive torque as a result of admitting more gas into the inlet region via the valves.

A suitable valve 65 is shown in FIG. 4. The valve has a stem 80 for closing the respective port, and inner and outer parts 81, 82 secured together by bolt 83. A piston 84 is slidable in chamber 85 in part 82 and has a through vent 86 and is connected to bellows seal 87, being held in place on stem 80 by nut 88. Pressure tappings 89, 90 communicate with opposite sides of the piston.

The compressor sections and expander sections automatically compensate for changes brought about by the fuel control system or a change in their working efficiency as follows. The low pressure compressor anti-over-pressurization valves are spring-loaded closed by their bellows, the innermost pressure tapping 89 is used to sense the pressure inside the machine annulus (i.e. the adjacent compartment) and the outer pressure tapping 90 is connected on line 65c to the high pressure expansion exhaust outlet.

The high pressure compressor anti-over-pressurization valves are spring-loaded closed by their bellows, the innermost pressure tapping 89 is used to sense the pressure inside the machine annulus. The outer-most tapping 90 is connected to pressure at compressor outlet 74.

The high pressure expansion exhaust anti-suction valves are spring-loaded open by their bellows; the outermost pressure tapping 90 is used to sense the pressure inside the machine annulus; the inner-most pressure tapping 89 is connected to the high pressure expansion exhaust outlet via line 65c, FIG. 5.

If desired there may be similar anti-suction valves immediately upstream of the low pressure exhaust opening. The number of vanes and associated parts in the rotary machines may vary and would typically be six or more. Preferably thrust bearings are provided to resist axial movement of vanes and maintain a running clearance between the side of the vanes and the machine side discs. Such a machine is generally as described in U.S. Pat. No. 4,831,827.

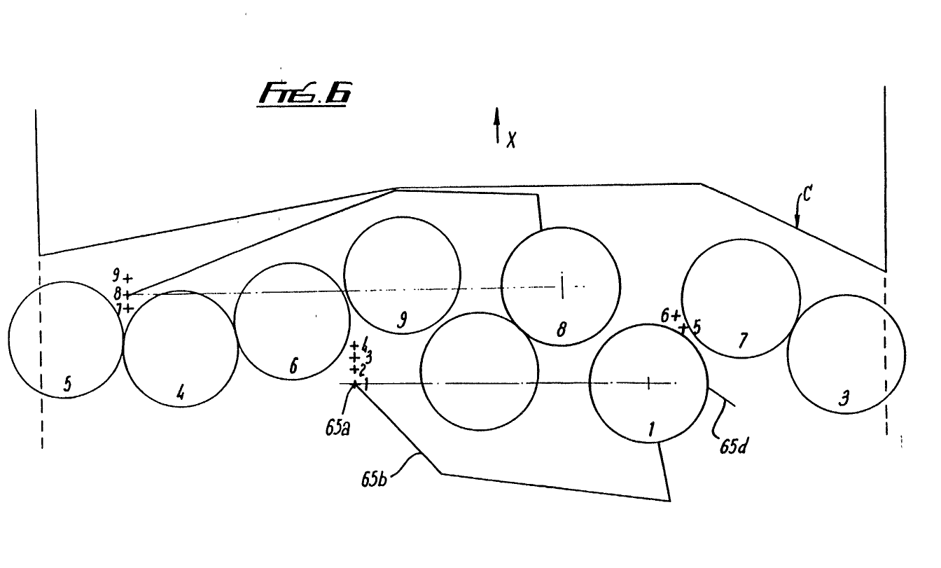

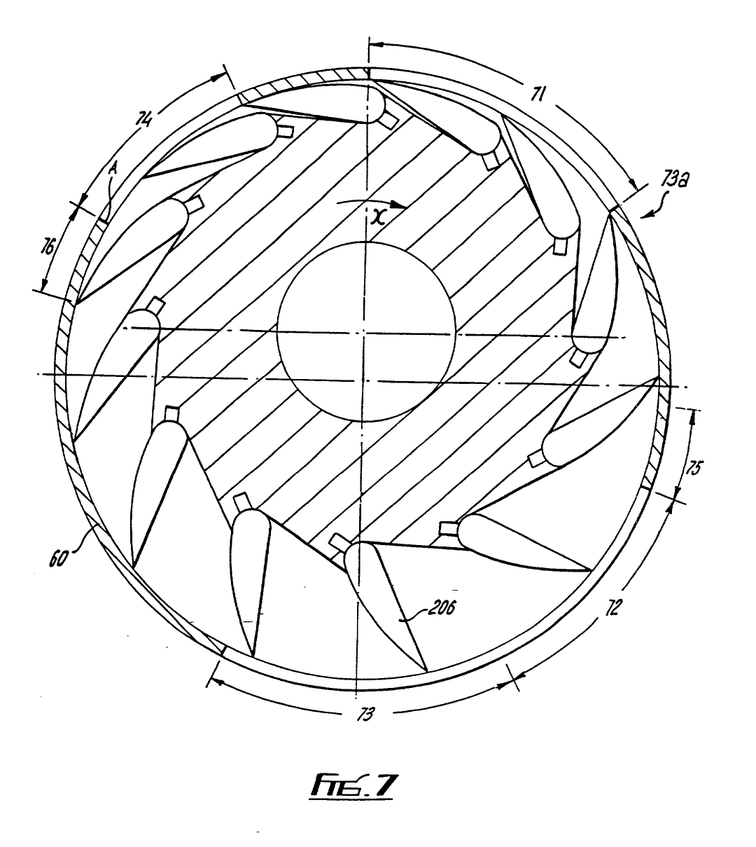

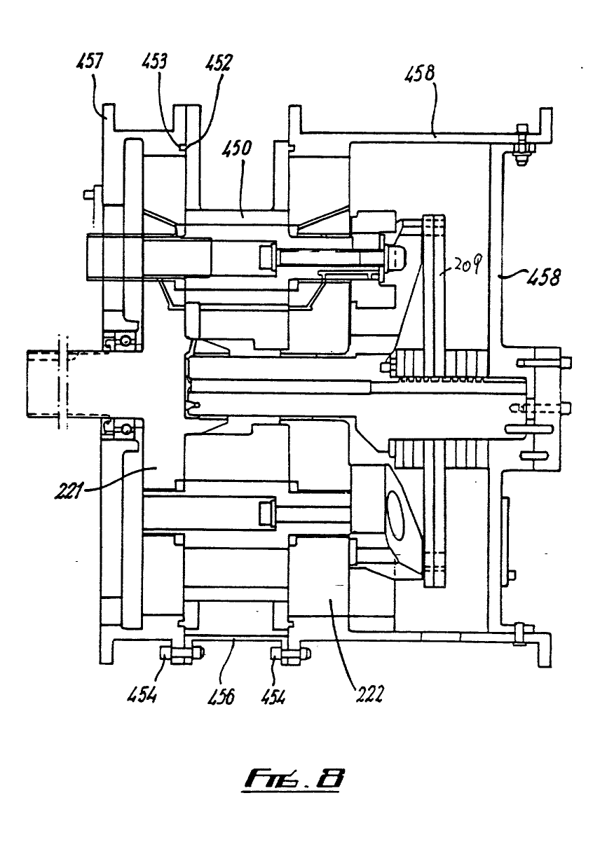

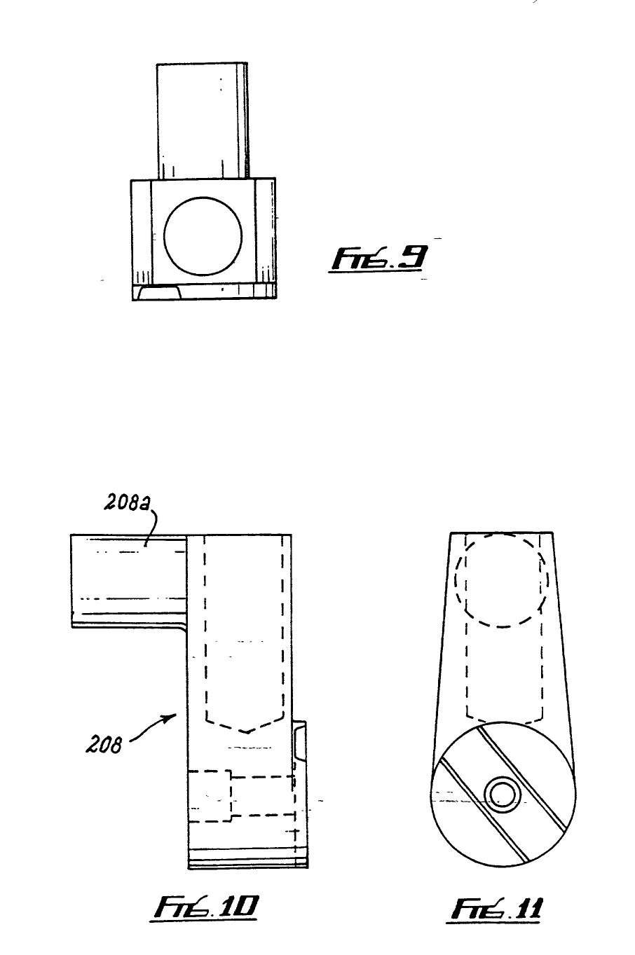

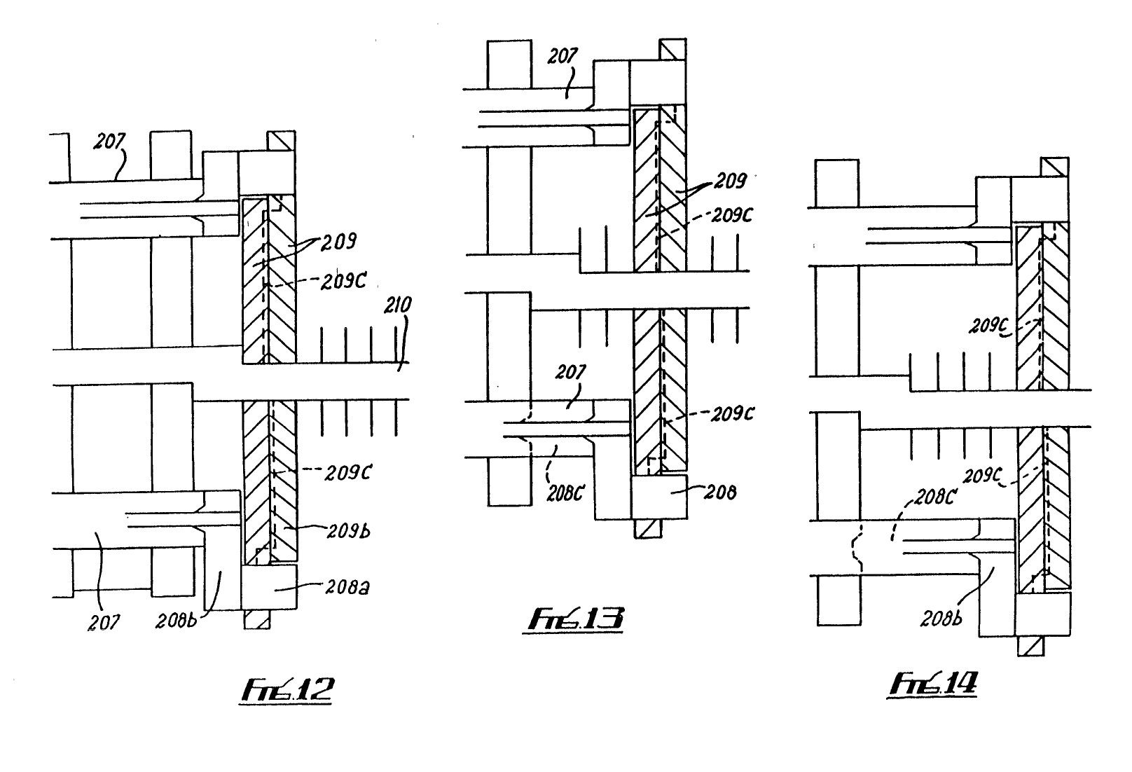

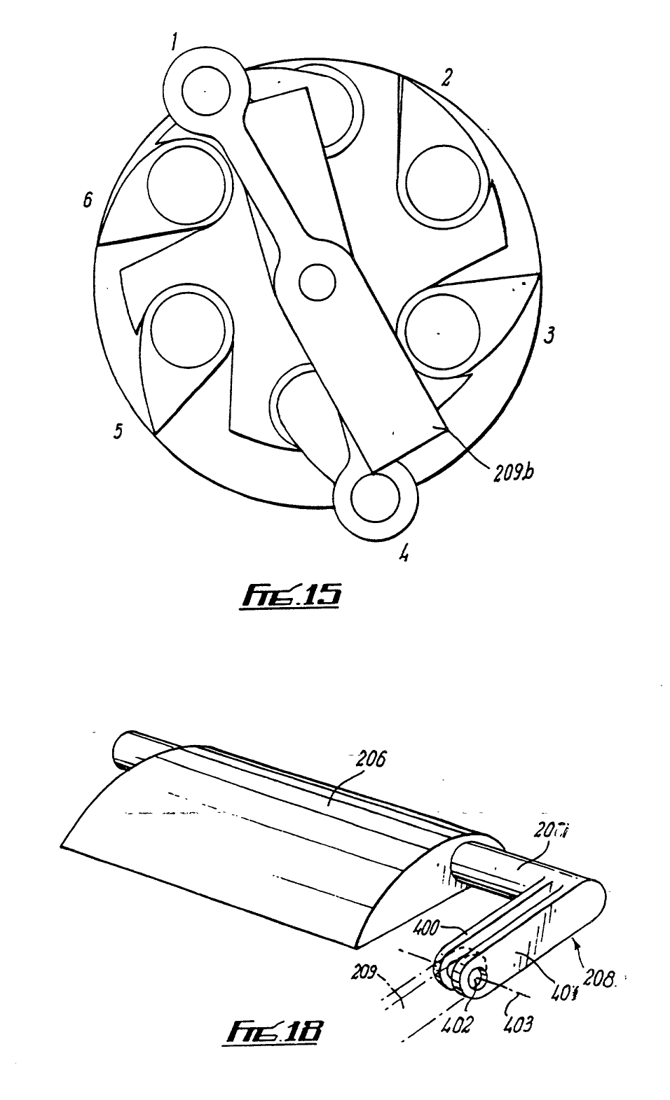

The present arrangements provide improvements or modifications of the above. In FIG. 8 the connecting arms or spokes 209 are radial and in pairs (in the case shown three pairs). The crank arms 208 FIGS. 9 to 11 are all the same shape but the vane pivot axles 207 for each pair are of different axial lengths (FIGS. 12 to 14). In this case the cranks in the different pairs move in different paths. Arms 208 include axial portion 208a on which the respective connecting arm 209 is pivotable. This reduces the strain on the axially outer crank arms 208a compared with an arrangement with parallel spokes 209 and axles 207 of the same axial length that requires crank arms of different shapes. The radial spokes 209 are in substantially parallel planes and each spoke has a radial portion 209b FIG. 15 on the opposite side of the center axis to axle 207 which at least one of which portions is grooved at 209c FIG. 12 in a confronting face for entry of lubricating oil from the bearings (not shown) between the spokes 209 and axle 210 and to the bearings (not shown) between the spokes 209 and the crank arms 208.

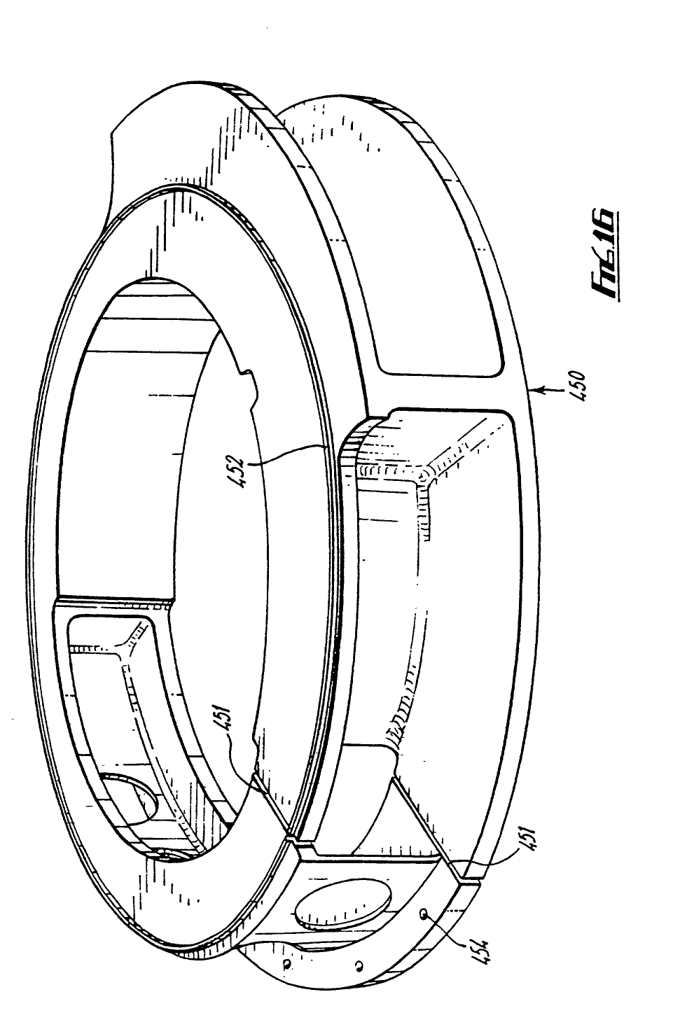

In a modification FIG. 17 in which there are for example six spokes 209, the axles 207 are the same shape and the crank arms 208 are all the same shape so that the crank arm portions 208a all extend axially the same extent but in this case the width of six spokes; the crank arms as a whole are all the same shape and the axles 207 all have equal axial length. The spokes 209 are at different positions on the arms 208a. In this case the crank arms move in a common path. If desired the outer end of each spoke may have an axial and arcuately extending extension 209d to provide an added bearing surface on the crank arm 208a.

In a further modification, the vane pivot axle components 207 may all have the same length so that the portions 208b of the crank arms 208 of the different pairs are of differing lengths as indicated dotted at 208c; the crank arms form part of the pivot axles. This applies whether portions 208a span two, six or some other number of spokes 209.

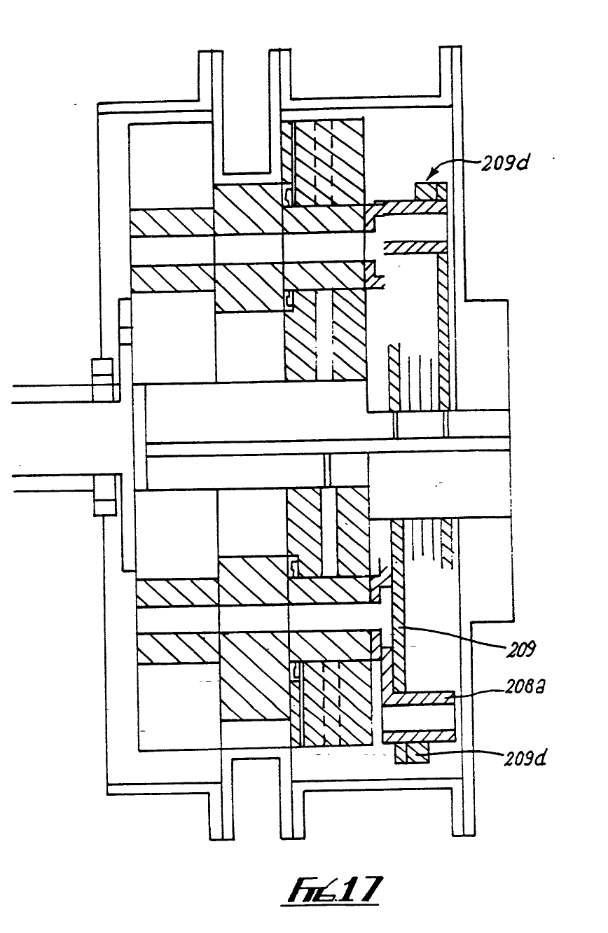

In the present case, see FIG. 18, because the arms 209 at their radially outer ends are radial they can be received between parallel arms 400, 401 integral with the crank arm 208 integral with axle 207. The vane is at 206. The arms 400, 401 replace portion 208b and portion 208a is omitted. Pivot pin 403 in holes 422 provides a pivot for spoke 209. In this case spoke portion 209b is omitted (FIG. 18A). This reduces the stress in the arrangement by substantially reducing twisting torque on arms 400, 401. The arms 209 can be entirely radial (FIG. 17) or radial at their radially inner and outer ends (FIG. 3).

When a circular ring heats up it will expand radially and there will be difficulty in controlling the tip clearance between the ring and a rotor inside the ring.

In the present example the ring 450 (casing 202) is cut along one radial line 451 FIG. 16 with a wide cut and another full ring 457, 458 FIG. 8 substantially of constant temperature with respect to the ring 450 is placed on each axial outside and close fitting to the inside ring 450. The inside ring will expand circumferentially and tend to close up the gap 451 but will stay sensibly the same diameter.

In the present example the casing 450 has circumferential axial spigot rings 452 FIGS. 8 and 16 on each side which fit in circumferential axial grooves 453 (FIG. 8) in the mating casings 457, 458. Location of the casings is made by bolting 454 all the casings together where the relative temperature is substantially constant with no substantial differential expansion. The spigots resist radial movement. In the case of an air compressor this is over about half the circumference where the air inlet is situated. For the remainder of the circumference, the casings on either side of the split center casing are connected together by a bridge 456 that spans the center casing 450.

In the present case, see FIG. 18, because the arms 209 at their radially outer ends are radial they can be received between parallel arms 400, 401 integral with the crank arm 208 integral with axle 207. The vane is at 206. The arms 400, 401 replace portion 208b and portion 208a is omitted. Pivot pin 403 in holes 402 provides a pivot for spoke 209. In this case spoke portion 209b is omitted (FIG. 18A). This reduces the stress in the arrangement by substantially reducing twisting torque on arms 400, 401. The arms 209 can be entirely radial (FIGS. 12 and 17) in which case the pivot axles are of differing lengths or the arms can be radial at their radially inner and outer ends (FIG. 3) in which case the pivot axles can have the same length. The respective vane, pivot axle and crank can be formed as one piece, reducing manufacturing costs.

FIG. 19 shows a perspective view of one arrangement and for assembly purposes the disc 404 (222) can be in two parts divided by an annular split line indicated schematically at 405 so that with suitable manipulation of the axles 207 the radially outer part is fitted first to support the axles and then the radially inner part can be fitted.

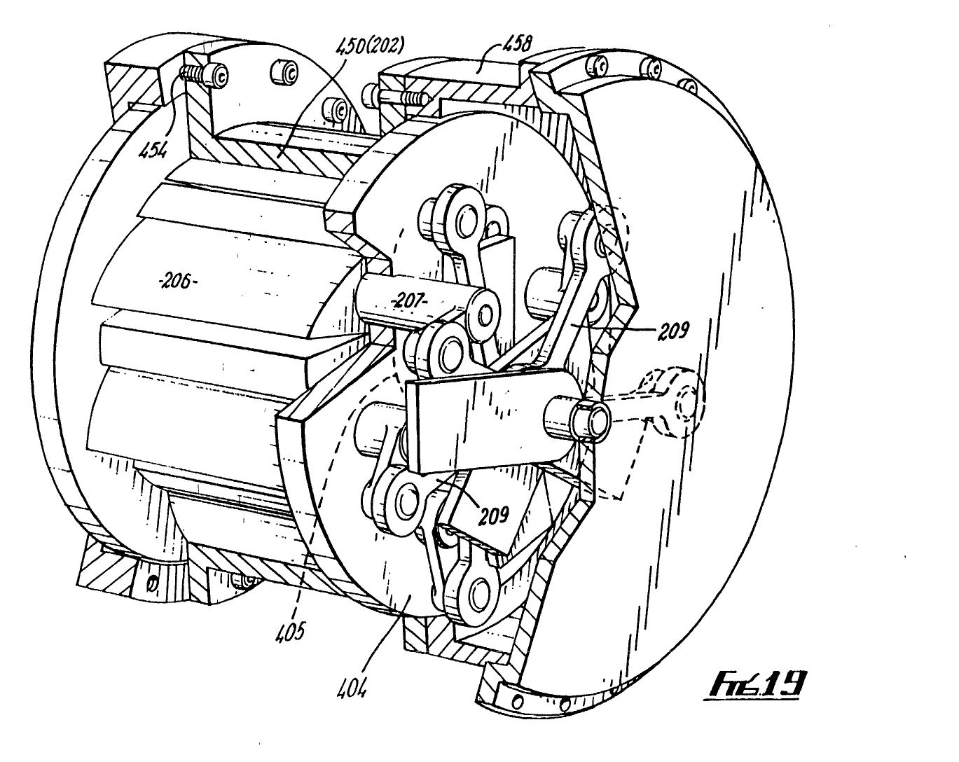

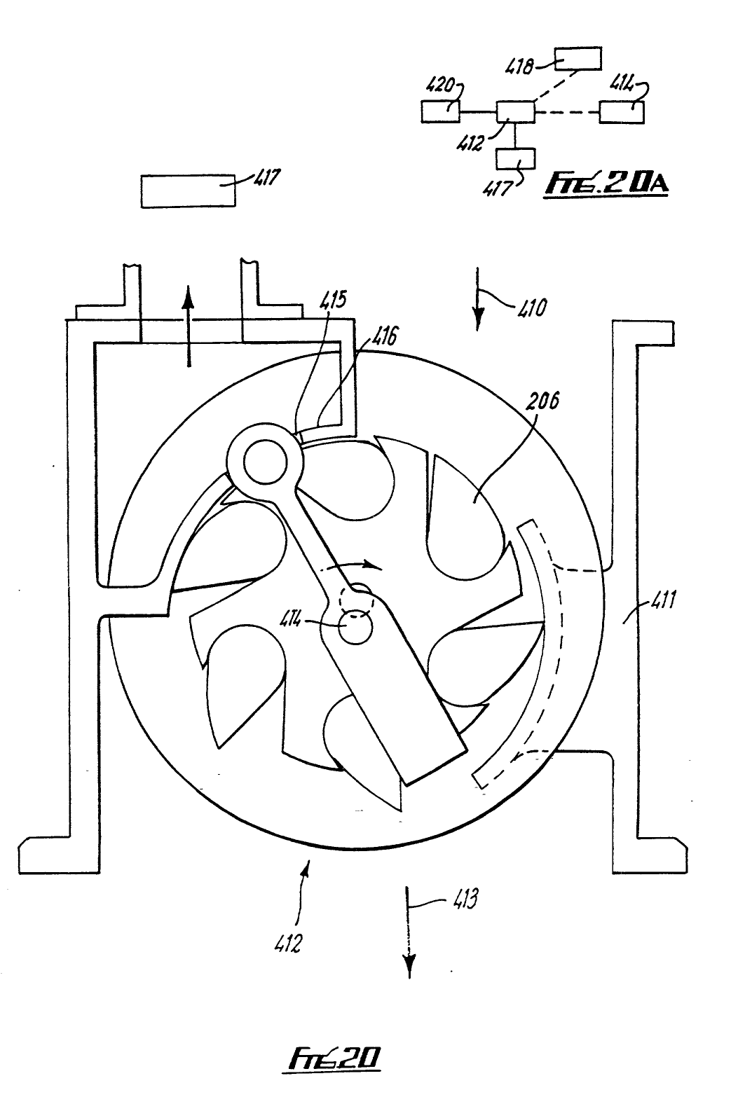

FIGS. 21 and 22 show a modification in which a sleeve 500 is fitted on shaft 210. The sleeve 500 revolves around shaft 210 and the spoke connecting arms 209 pivot on the outside diameter of the sleeve. The sleeve 500 has two end plates 501 and the three components are clamped by bolts and nuts 503. The sleeve can be free to rotate by any rubbing contact with mating parts or positively driven by either rotating pegs or meshing gear teeth. Thus engagement with end disc 222 may provide a friction drive; or pegs 504 may extend from disc 222 and engage in scalloped peripheral recesses 505 FIG. 23; or engaging gear teeth 506 may be provided on disc 222 and a plate 501 FIG. 24. The sleeve can be applied to any of the spoke and crank arm designs and enables a simple bearing 5 10 to be used between the sleeve and the shaft 210.

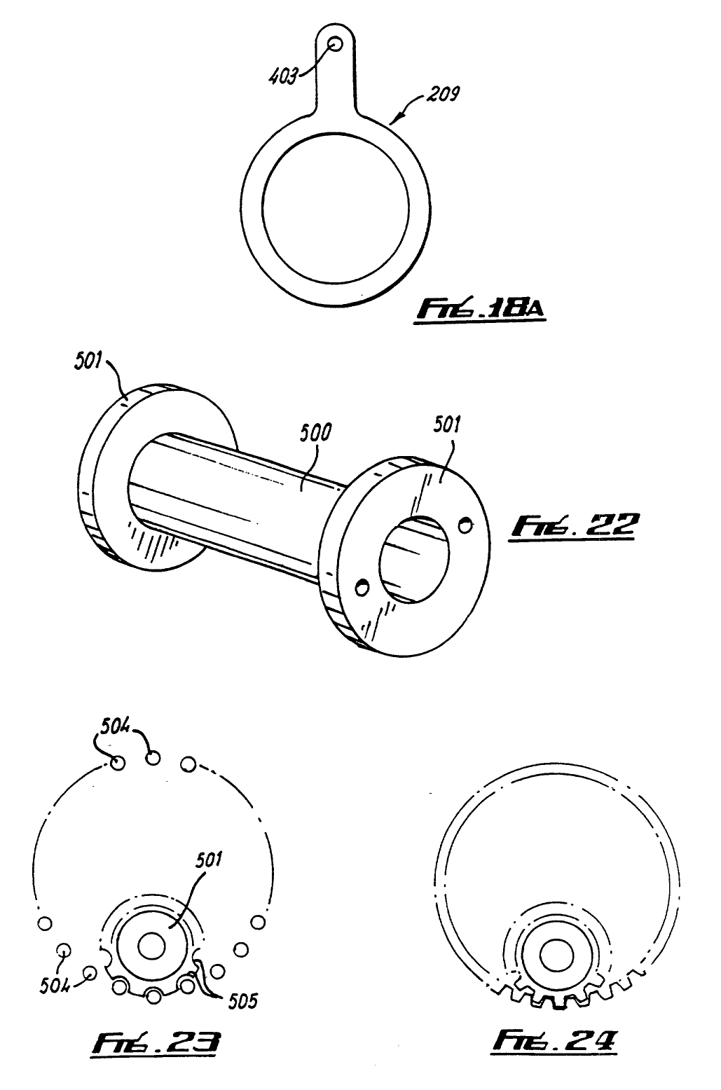

A rotary device 412 having a linkage with a slider, or a plurality of crank arms, may be employed in various environments. For example, any of the above arrangements may be used in combination with an internal combustion engine. In the example shown in FIG. 20 air inlet 410 admits air to casing 411 housing rotary device 412 and air outlet 413 communicates with the engine inlet manifold. When the engine is idling or at low speed, the pressure in the inlet manifold is less than ambient outside casing 411 and the pressure difference rotates the device 412. The device 412 is operatively coupled to the engine crankshaft indicated schematically at 414 thus reducing fuel consumption significantly, perhaps 20% because the energy to create the pressure difference normally is derived from the engine; the described arrangement transmits some of this throttle loss back to the engine.

An outlet 415 may be provided in rotary casing 416 leading to the fuel injection device 417 and at a cold start when the device 412 is rotated initially by the starter motor 420, cold compressed air is delivered at outlet 415 and device 417 to atomize the fuel being injected and thus increasing the chance of ignition thus improving the chance of starting the engine. This feature can be applied also to a sliding vane rotary device.

The device 412 can, if desired, be connected additionally or alternatively to an alternator to charge a battery, which itself may be connected to drive the engine; and the device can be driven by a separate supply of compressed air or the pressure difference between ambient and the inlet manifold.

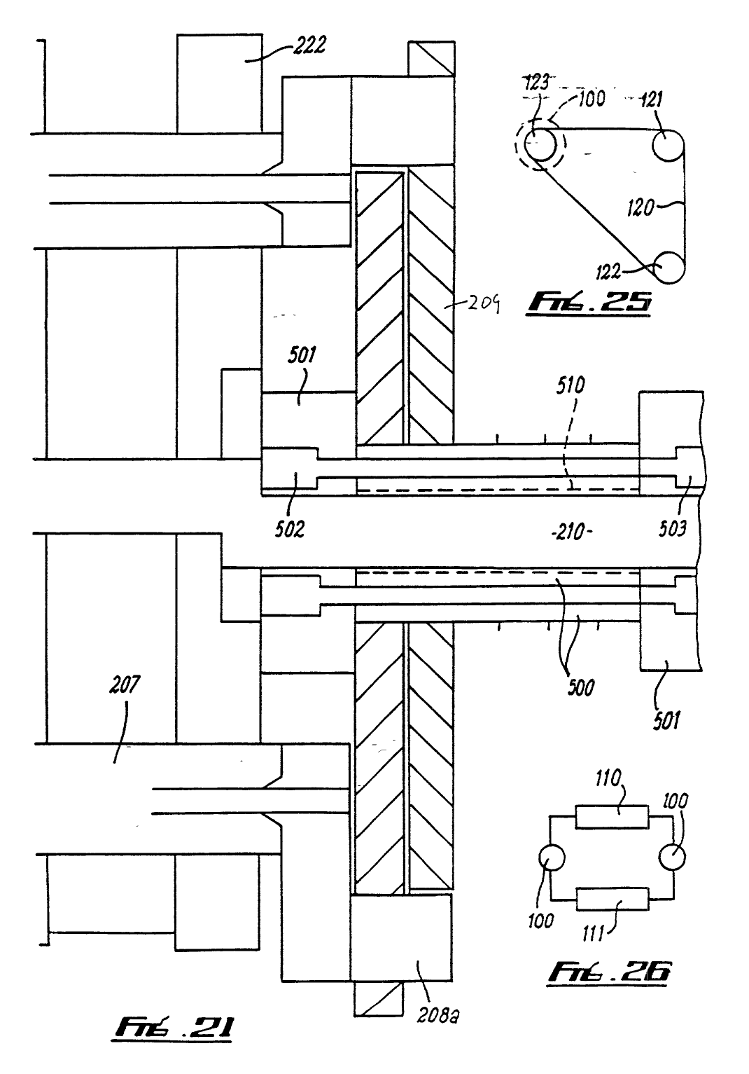

The device 412 can be used as a compressed-air driven starter motor for an internal combustion engine, to replace an electrically-powered starter motor, by operatively coupling the rotor to the engine crankshaft and driving the motor by compressed air from a supply 418, FIG. 21. FIG. 25 shows a toothed belt 120 coupling pulleys 123, 122, 121 rotatable respectively with a device 100, the crank shaft and the cam shaft of the engine.

The device 100 can be used (FIG. 26) in a circuit with expansion and compression heat exchangers 110, 111, the two devices 100 shown acting respectively as expanders and compressors of refrigerant flowing in the circuit or the expansion and compression could be combined in one unit. One of the heat exchangers 110, 111 may take the compressed fluid to act as a heat source. The circuit could be an air conditioning circuit with the device acting as an expander. The rotor may for example rotate at about 3600 revolutions per minute so that much less of the usable energy is absorbed in bringing the fluid up to rotor speed than in a device which rotates at for example 60000 revolutions.

The internal combustion engine can be static or in a vehicle.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What is claimed is:

1. An internal combustion engine in combination with a rotary positive displacement fluid machine having a rotor eccentrically mounted in a casing with a plurality of vanes defining compartments within the casing which vary in volume as the rotor rotates, each vane being connected to a linkage to cause the vane, during rotation of the rotor, to pivot radially outwardly such that the outermost extremity of each vane is constrained to follow closely the internal wall of the casing, said linkage being constrained to follow at least one track in a member rotatable upon the same axis as the casing, the machine being connected to an air inlet manifold of the engine, and to atmosphere, such that the rotor is driven by the pressure difference between ambient air and air at the inlet manifold, the machine being operatively connected to an energy using device.

2. The combination according to claim 1, wherein the said linkage is slidably engaged with at least one groove in said member.

3. The combination according to claim 2, wherein said linkage is slidably engaged within a pair of grooves.

4. The combination according to claim 2, including a lubricator provided within at least one of the pair of grooves.

5. The combination according to claim 2, wherein said at least one groove is provided in a disc which is freely rotatably mounted about the center of the circle described by the vane tips whereby its rotational speed is determined by any friction drag forces of the linkage within the at least one groove.

6. The combination according to claim 5, wherein the rotational speed of the disc is approximately the speed of rotation of the rotor.

7. The combination according to claim 2, wherein each vane is pivotally mounted on a shaft, on one or both ends of which is a crank arm, from the radially outer end of which there extends in a direction parallel to the shaft a slipper adapted to slide within the groove or grooves.

8. The combination according to claim 7, wherein the linkage comprises a pair of stub axles pivotally mounted within a slipper adapted to slide within the at least one groove whereby the slipper is attached to the pair of stub axles to ensure that the load placed upon the slipper is approximately evenly distributed.

9. The combination according to claim 6, wherein each crank arm is bonded to its associated vane shaft.

10. The combination according to claim 1, wherein said linkage is engaged within a least one groove in said member by an anti-friction bearing.
